(19) United States
(12) Patent Application Publication
(10) Pub. No.: US 2023/0092279 A1
(43) Pub. Date: Mar. 23, 2023

(54) PRINTING SYSTEM, PRINT SERVER, AND PRINTING CONTROL METHOD

(71) Applicant: Satoru Tao, Kanagawa (JP)

(72) Inventor: Satoru Tao, Kanagawa (JP)

(73) Assignee: Ricoh Company, Ltd., Tokyo (JP)

(21) Appl. No.: 17/822,878

(22) Filed: Aug. 29, 2022

(30) Foreign Application Priority Data
Sep. 17, 2021 (JP) 2021-152073

(51) Int. Cl. G06F 3/12

(52) U.S. Cl. CPC G06F 3/1205; G06F 3/1288; G06F 3/1255; G06F 3/1206; G06F 3/1248; G06F 3/1247; G06F 3/1267; G06F 3/1232

(57) ABSTRACT

A printing system includes a print server and a relay device communicably connected with the print server and an image forming apparatus. The print server includes circuitry that checks whether electronic data to be printed is printable by the image forming apparatus in accordance with a print condition of the electronic data, causes the relay device to display a change screen for receiving a change of the print condition in a case where the electronic data is not printable by the image forming apparatus in accordance with the print condition, converts, in a case where the print condition is changed, the electronic data into print data printable by the image forming apparatus in accordance with the changed print condition, and transmits the print data to the relay device.

### CROSS-REFERENCE TO RELATED APPLICATIONS

This patent application is based on and claims priority pursuant to 35 U.S.C. § 119(a) to Japanese Patent Application No. 2021-152073, filed on Sep. 17, 2021, in the Japan Patent Office, the entire disclosure of which is hereby incorporated by reference herein.

### BACKGROUND

### Technical Field

The present disclosure relates to a printing system, a print server, and a printing control method.

### Related Art

In a printing system of the related art, a print server or the like in a network is used from an information terminal so that electronic data to be subjected to printing is printed by an image forming apparatus.

In another printing system of the related art, an agent in a network detects a printer that is connected to the network; notifies a server of the detected printer; receives, from the server, print data converted by the server from data to be subjected to printing; and transfers the print data to the printer.

### SUMMARY

In an aspect of the present disclosure, a printing system includes a print server and a relay device communicably connected with the print server and an image forming apparatus. The print server includes circuitry. The circuitry checks whether electronic data to be printed is printable by the image forming apparatus in accordance with a print condition of the electronic data. The circuitry causes the relay device to display a change screen for receiving a change of the print condition in a case where the electronic data is not printable by the image forming apparatus in accordance with the print condition. The circuitry converts, in a case where the print condition is changed, the electronic data into print data printable by the image forming apparatus in accordance with the changed print condition. The circuitry transmits the print data to the relay device.

In another aspect of the present disclosure, a print server connected, via a communication network, to a relay device capable of communicating with an image forming apparatus, includes circuitry. The circuitry checks whether electronic data to be printed is printable by the image forming apparatus in accordance with a print condition of the electronic data. The circuitry causes the relay device to display a change screen for receiving a change of the print condition in a case where the electronic data is not printable by the image forming apparatus in accordance with the print condition. The circuitry converts, in a case where the print condition is changed, the electronic data into print data printable by the image forming apparatus in accordance with the changed print condition. The circuitry transmits the print data to the relay device.

In still another aspect of the present disclosure, a printing control method includes checking whether electronic data to be printed is printable by an image forming apparatus in accordance with a print condition of the electronic data; causing a relay device capable of communicating with the image forming apparatus to display a change screen for receiving a change of the print condition in a case where the electronic data is not printable by the image forming apparatus in accordance with the print condition; converting, in a case where the print condition is changed, the electronic data into print data printable by the image forming apparatus in accordance with the changed print condition; and transmitting the print data to the relay device.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a system configuration of a printing system according to one or more embodiments;

FIG. 2 is a block diagram illustrating an example of a hardware configuration of a computer according to the one or more embodiments;

FIG. 3 is a block diagram illustrating an example of a hardware configuration of a relay device according to the one or more embodiments;

FIG. 4 is a block diagram illustrating an example of a functional configuration of a print server according to the one or more embodiments;

FIGS. 5A and 5B are diagrams illustrating examples of information managed by the print server according to the one or more embodiments;

FIG. 6 is a diagram illustrating an example of a functional configuration of the printing system according to the one or more embodiments;

FIG. 7 is a sequence diagram illustrating an example of a device setting process according to a first embodiment;

FIG. 8 is a sequence diagram illustrating an example of a print job registration process according to the first embodiment;

FIG. 9 is a sequence diagram illustrating an example of a printing process according to the first embodiment;

FIG. 10 is another sequence diagram illustrating the example of the printing process according to the first embodiment;

FIGS. 11A to 11E are diagrams each illustrating an example of a displayed screen according to the first embodiment;

FIG. 12 is a sequence diagram illustrating an example of a print job registration process according to a second embodiment;

FIG. 13 is a sequence diagram illustrating an example of a printing process according to the second embodiment; and

FIG. 14 is another sequence diagram illustrating the example of the printing process according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure will be described in detail below with reference to the drawings.

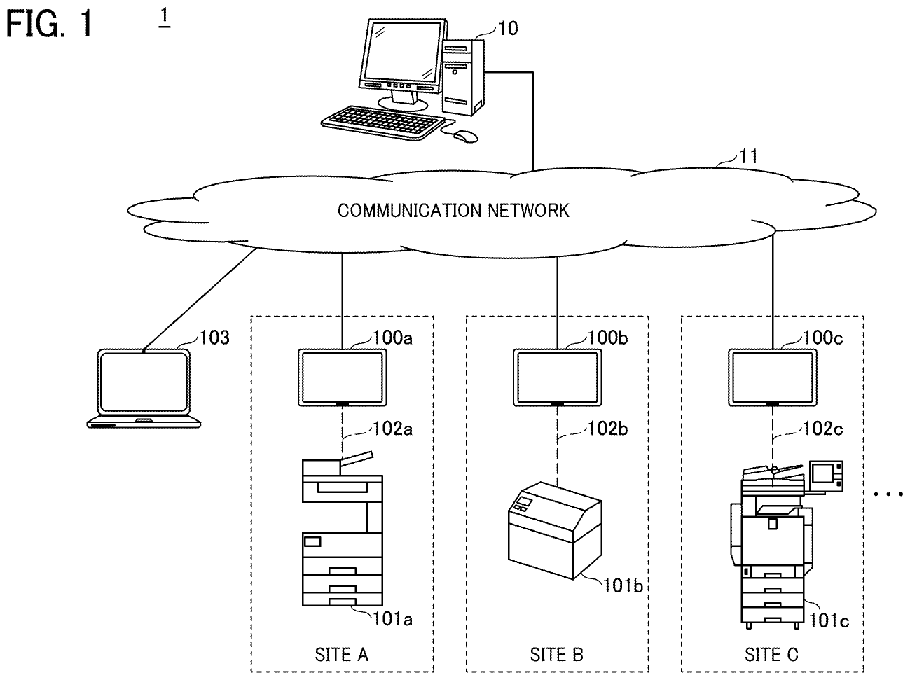

System Configuration FIG. 1 is a diagram illustrating an example of a system configuration of a printing system according to one or more embodiments. A printing system 1 includes, for example, a print server 10, a plurality of relay devices 100a, 100b, and 100c, . . . , and an information terminal 103 that are connected to a communication network 11 such as the Internet or a local area network. In the description below, any one of the relay devices 100a, 100b, 100c, . . . is referred to as a “relay device 100”. The number of relay devices 100 illustrated in FIG. 1 is merely an example and may be one or more.

The relay device (repeater) 100 is an electronic device having a configuration of a computer and having functions such as a communication function, a display function, and an operation reception function. The relay device 100 is communicably connected to the print server 10 via the communication network 11. In the example illustrated in FIG. 1, the relay device 100a is communicably connected to an image forming apparatus 101a via, for example, a local network 102a at a site A. The relay device 100b is communicably connected to an image forming apparatus 101b via, for example, a local network 102b at a site B. Likewise, the relay device 100c is communicably connected to an image forming apparatus 101c via, for example, a local network 102c at a site C. In the description below, any one of the image forming apparatuses 101a, 101b, 101c, . . . is referred to as an “image forming apparatus 101”.

The image forming apparatus 101 is an image forming apparatus, for example, a printer or a multifunction peripheral (MFP), having a communication function and a printing function. In the present embodiments, the image forming apparatus 101 connected to the relay device 100 may be any image forming apparatus having a communication function and a printing function. Examples of the image forming apparatus 101 may include a printer not supporting color printing, a printer not supporting double-sided printing, a printer not having a stapling function, a printer supporting just printing on sheets of A4 size or smaller, or a printer not having an operation panel. The image forming apparatus 101 may include printers, MFPs, or the like of different manufacturers.

The information terminal 103 is, for example, an information processing apparatus such as a personal computer (PC), a tablet terminal, or a smartphone. A user can use the information terminal 103 to create, for example, document data which is an example of electronic data and to register a print job for printing the created document data in the print server 10.

A print job is a set of a series of electronic files related to a print request transmitted from the information terminal 103 to the print server 10. For example, a print job includes document data (i.e., electronic data) to be subjected to printing and print setting information indicating printing conditions of the document data. The print setting information is hereinafter referred to as print conditions. The print job may further include print data resulting from Page Description Language (PDL) conversion of the document data into a format printable by the image forming apparatus 101 in accordance with the print conditions. The print conditions include various kinds of setting information related to printing of document data, such as a sheet size, color printing, double-sided printing, or stapling, for example.

The description below will be given on the assumption that the information terminal 103 is a PC. Alternatively, the information terminal 103 may be another type of information processing apparatus such as a tablet terminal or a smartphone, for example.

The print server 10 is an information processing apparatus having a configuration of a computer or is a system including a plurality of computers, for example. The print server 10 is communicably connected to the information terminal 103 and the plurality of relay devices 100 via the communication network 11. The print server 10 stores and manages a print job, i.e., document data and print conditions included in a print request received from the information terminal 103, for each user in a memory, for example.

In one embodiment, for example, when the user designates the image forming apparatus 101a at the site A and transmits a print request from the information terminal 103, the print server 10 performs, in accordance with the print conditions, PDL conversion on document data to be subjected to printing to obtain print data printable by the image forming apparatus 101a. In this case, the print server 10 stores and manages the document data to be subjected to printing, the print conditions, and the print data, as a print job, for each user in a memory.

In response to the user who has registered the print job logging into, for example, the relay device 100a, the print server 10 causes the relay device 100a to display a print execution screen. For example, in response to receipt of a print execution operation in the print execution screen, the print server 10 transmits the print data printable by the image forming apparatus 101a to the relay device 100a. The relay device 100a then transfers the print data received from the print sever 10 to the image forming apparatus 101a. Thus, the user can print the document data registered in the print server 10 by using the image forming apparatus 101a in a secure manner.

In recent years, there is a request for printing electronic data to be subjected to printing at various places, for example, a home, a remote office, a library, and a cafe as a result of the work style reform or the spread of work-from-home.

For example, suppose that a user who has a high degree of freedom in terms of a place where the user works registers a print job for double-sided color printing of document data with the image forming apparatus 101a at the site A which is, for example, a library. In such a case, for example, even if the user wishes to change the destination of printing to the image forming apparatus 101b at the site B which is, for example, a cafe because of a closed day, a failure, or a congestion, for example, it is difficult to change the destination of printing in reality.

For example, when the image forming apparatus 101b at the site B does not support color printing or double-sided printing, the document data may be subjected to single-sided monochrome printing against the user's intention. When the manufacturer, model, or the like of the image forming apparatus 101b at the site B is different from that of the image forming apparatus 101a at the site A, printing itself may not be executable.

In such a case, in the related art, the user uses, for example, the information terminal 103 to cancel the print job registered for the image forming apparatus 101a at the site A and to then newly register the print job for the image forming apparatus 101b at the site B.

As described above, in the related art, for example, it is difficult to output a print job registered in a print server to perform printing with the image forming apparatus 101a at the site A, to for example the image forming apparatus 101b that is installed at another site B and of which the manufacturer, the model, the option, or the like is different.

Accordingly, for example, in response to the user logging into the relay device 100b at the site B, the printing system 1 according to the present embodiments checks whether the print job registered in the print server 10 is printable by the image forming apparatus 101b in accordance with the print conditions. The print job is an example of electronic data to be subjected to printing.

When printing based on the print job is not executable in accordance with the print conditions, the printing system 1 causes the relay device 100b to display a change screen that receives a change of the print conditions. In response to a change of the print conditions, the printing system 1 converts the document data into print data printable by the image forming apparatus 101b in accordance with the changed print conditions, and transmits the converted print data to the image forming apparatus 101b via the relay device 100b. Thus, the present embodiments make it easier to output, for example, a print job registered in the print server 10 to perform printing with the image forming apparatus 101a at the site A, to the image forming apparatus 101b which is installed at the other site B and of which the manufacturer, model, option, or the like is different.

Likewise, it becomes easier for the user to output a print job registered in the print server 10 to perform printing with the image forming apparatus 101a at the site A, to the image forming apparatus 101c which is installed at another site C and of which the manufacturer, model, option, or the like is different.

The system configuration of the printing system 1 illustrated in FIG. 1 is merely an example. For example, at least some of the relay devices 100a, 100b, 100c, . . . and the image forming apparatuses 101a, 101b, 101c, . . . may be installed at the same site or may be connected to the same local network.

A plurality of image forming apparatuses 101 may be connected to one relay device 100. In this case, the relay device 100 may display a selection screen for selecting the image forming apparatus 101 serving as the destination of printing in response to the user logging into the relay device 100.

### Hardware Configuration

### Hardware Configuration of Computer

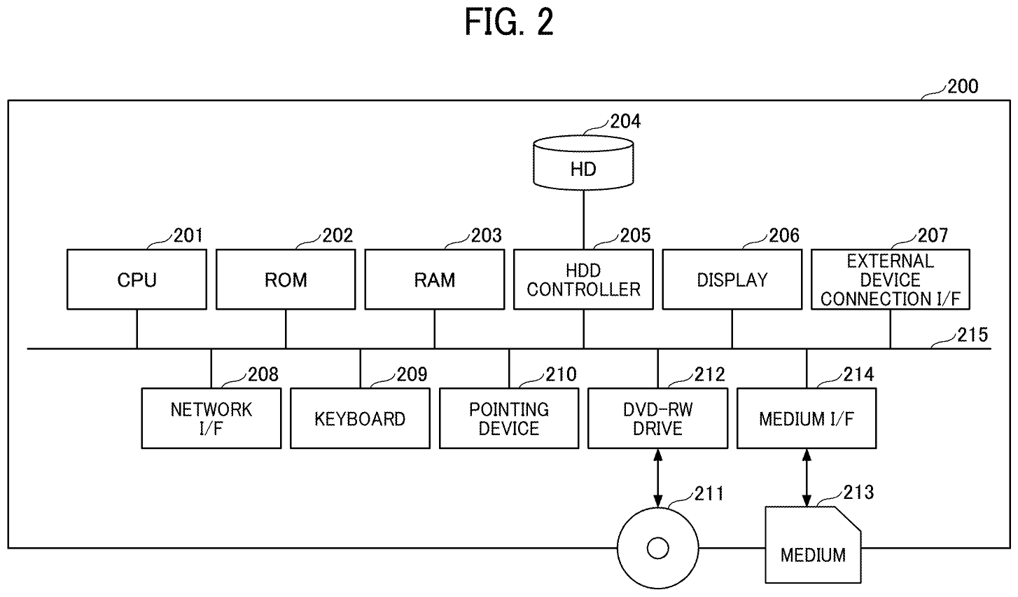

For example, the information terminal 103 has a hardware configuration of a computer 200 as illustrated in FIG. 2. For example, the print server 10 is implemented by one or more computers 200.

FIG. 2 is a block diagram illustrating an example of the hardware configuration of the computer 200 according to the one or more embodiments. As illustrated in FIG. 2, the computer 200 includes, for example, a central processing unit (CPU) 201, a read-only memory (ROM) 202, a random access memory (RAM) 203, a hard disk (HD) 204, a hard disk drive (HDD) controller 205. The computer 200 also includes a display 206, an external device connection interface (I/F) 207, a network I/F 208, a keyboard 209, a pointing device 210, a digital versatile disc rewritable (DVD-RW) drive 212, a medium I/F 214, and a bus line 215.

The CPU 201 controls operations of the entire computer 200. The ROM 202 stores a program used for booting the computer 200, such as an initial program loader (IPL), for example. The RAM 203 is used as, for example, a work area for the CPU 201. The HD 204 stores, for example, programs such as an operating system (OS), an application, and a device driver, and various kinds of data. The HDD controller 205 controls, for example, reading of various kinds of data from and writing of various kinds of data to the HD 204 under control of the CPU 201.

The display 206 displays various kinds of information, for example, a cursor, a menu, a window, a text, or an image. The display 206 may be external to the computer 200. The external device connection I/F 207 is an interface for connecting various external devices to the computer 200. The network I/F 208 is an interface for connecting the computer 200 to the communication network 11 and for communicating with other devices via the communication network 11.

The keyboard 209 is an example of an input device including a plurality of keys with which the user inputs characters, numerals, and various instructions, for example. The pointing device 210 is an example of an input device with which the user selects or executes various instructions, selects a processing target, or move a cursor. The keyboard 209 and the pointing device 210 may be external to the computer 200.

The DVD-RW drive 212 controls reading of various kinds of data from and writing of various kinds of data to a DVD-RW 211, which is an example of a removable recording medium. The removable recording medium is not limited to the DVD-RW 211 and may be another type of recording medium. The medium I/F 214 controls reading of data from or writing (storing) of data to a medium 213 such as a flash memory. The bus line 215 includes an address bus, a data bus, various control signal buses, and the like for electrically connecting each of the above components.

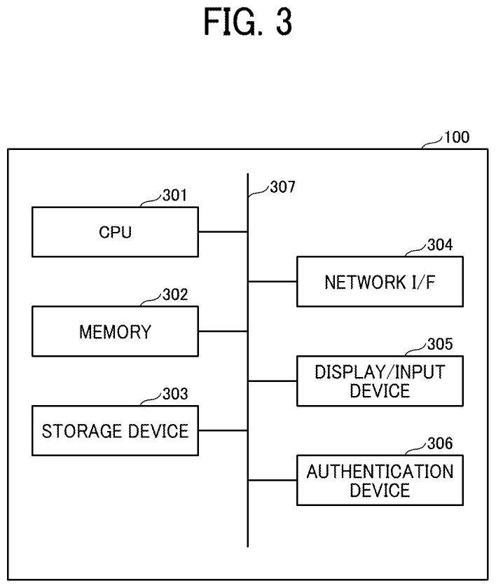

Hardware Configuration of Relay Device FIG. 3 is a diagram illustrating an example of a hardware configuration of the relay device 100 according to the one or more embodiments. The relay device 100 includes, for example, a CPU 301, a memory 302, a storage device 303, a network I/F 304, a display/input device 305, an authentication device 306, and a bus 307.

The CPU 301 is, for example, a processor that executes a predetermined program stored in the storage device 303 or the like to implement functions of the relay device 100. The memory 302 includes, for example, a RAM that is a volatile memory used as a work area of the CPU 301, a ROM that is a nonvolatile memory that stores a program for booting the CPU 301, and the like. The storage device 303 is a large-capacity storage device that stores an OS, a program for the relay device 100, and various kinds of data. The storage device 303 is implemented by, for example, a solid state drive (SSD), an HDD, or the like.

The network I/F 304 is a communication interface that connects the relay device 100 to the communication network 11, a local network, or the like. The display/input device 305 is a device having a display function and an input function, such as a touch panel display, for example.

The display/input device 305 may be separated to a display device having the display function such as a liquid crystal display, and an input device having the input function such as a keyboard.

Examples of the authentication device 306 may include a reader that reads biometric information for biometric authentication, a card reader that reads a card ID for card authentication, or short-range wireless communication circuitry.

When password-based authentication is performed using the display/input device 305, the authentication device 306 may be omitted from the relay device 100. The bus 307 is coupled to the above-described components in common. The bus 307 transmits an address signal, a data signal, and various control signals, for example.

### Functional Configurations

Functional configurations of the print server 10 and the printing system 1 will be described next.

### Functional Configuration of Print Server

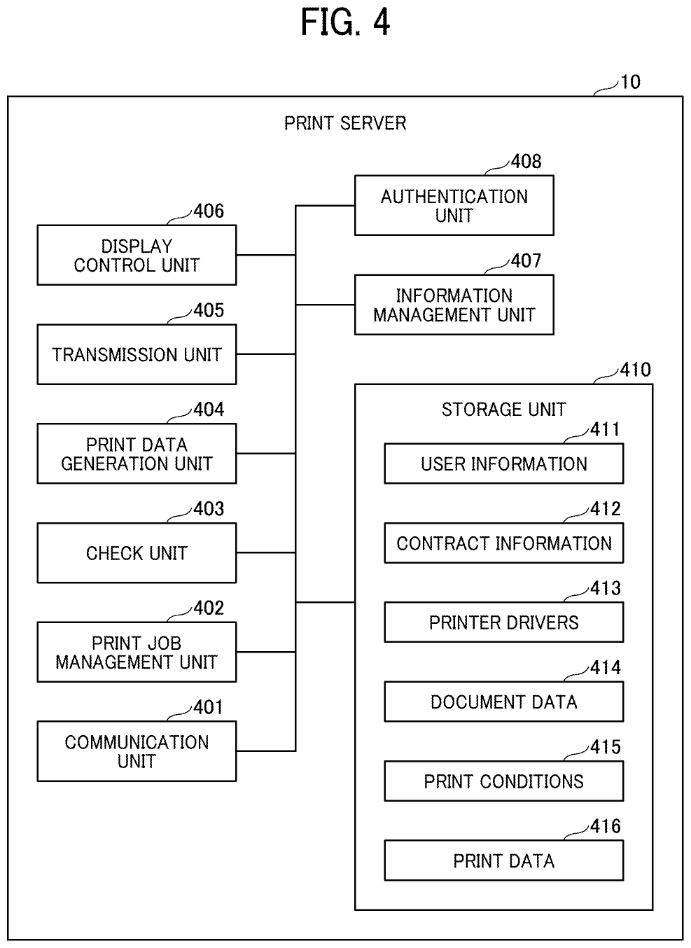

FIG. 4 is a block diagram illustrating an example of a functional configuration of the print server 10 according to one or more embodiments. The one or more computers 200 of the print server 10 execute a predetermined program, so that the print server 10 implements a functional configuration illustrated in FIG. 4. In the example of FIG. 4, the print server 10 has a functional configuration including a communication unit 401, a print job management unit 402, a check unit 403, a print data generation unit 404, a transmission unit 405, a display control unit 406, an information management unit 407, an authentication unit 408, and a storage unit 410. At least a part of the above-described functional configuration may be implemented by hardware.

The communication unit 401 connects the computer 200 to the communication network 11 using, for example, the network I/F 208, and performs a communication process of communicating with the information terminal 103, the relay devices 100, and so on

The print job management unit 402 performs a print job management process of storing and managing document data 414 and print conditions 415 of the document data 414 for each user in the storage unit 410, for example. The document data 414 and the print conditions 415 of the document data 414 are included in a print request received from the information terminal 103. The print job management unit 402 also performs a process of storing and managing print data 416 generated by the print data generation unit 404 in the storage unit 410 in association with the document data 414 and the print conditions 415.

The check unit 403 performs a check process of checking whether the image forming apparatus 101, which is the destination of printing, is capable of printing the document data 414 to be subjected to printing, which is electronic data, in accordance with the print conditions 415 of the document data 414.

For example, in response to the user logging into the relay device 100b, the check unit 403 acquires device information of the image forming apparatus 101b from the relay device 100b. This device information includes, for example, information on the PDL, sheet sizes, color or monochrome printing, single-sided or double-sided printing, stapling, scanning, and the like that can be handled by the image forming apparatus 101b. The information on the PDL includes, for example, information on a format of print data printable by the image forming apparatus 101b, such as PostScript (registered trademark), Page Control Language (PCL), or Refine Printing Command System (RPCS (registered trademark)).

Based on the print conditions 415 of the document data 414 and the device information of the image forming apparatus 101b, the check unit 403 checks whether the document data 414 is printable by the image forming apparatus 101b in accordance with the print conditions 415. In one specific example, the check unit 403 may check whether the document data 414 is printable by the image forming apparatus 101b based on whether a printer driver for the image forming apparatus 101b stored in advance in the storage unit 410 can perform PDL conversion on the document data 414 in accordance with the print conditions 415.

The print data generation unit 404 performs a print data generation process of converting the document data 414 to be subjected to printing into print data printable by the image forming apparatus 101 that is the destination of printing in accordance with the print conditions 415. If the user changes the print conditions 415 of the document data 414, the print data generation unit 404 converts the document data 414 into print data printable by the image forming apparatus 101, which is the destination of printing, in accordance with the changed print conditions 415.

The transmission unit 405 performs a transmission process of transmitting the print data generated by the print data generation unit 404 to the relay device 100. For example, in response to the user changing the print conditions 415 of the document data 414 in the relay device 100b, the transmission unit 405 transmits the print data obtained by the print data generation unit 404 through conversion to the image forming apparatus 100b, which is the destination of printing, via the relay device 101b.

The display control unit 406 performs a display control process of causing the relay device 100 or the information terminal 103 to display various display screens to be described later. For example, the display control unit 406 functions as a web server that provides web pages for displaying various display screens to the relay device 100 or the information terminal 103.

The information management unit 407 performs, for example, an information management process of storing and managing user information 411, contract information 412, and the like in the storage unit 410. The user information 411 is information on a user registered in the printing system 1. The contract information 412 is information on a device for which the user has a contract.

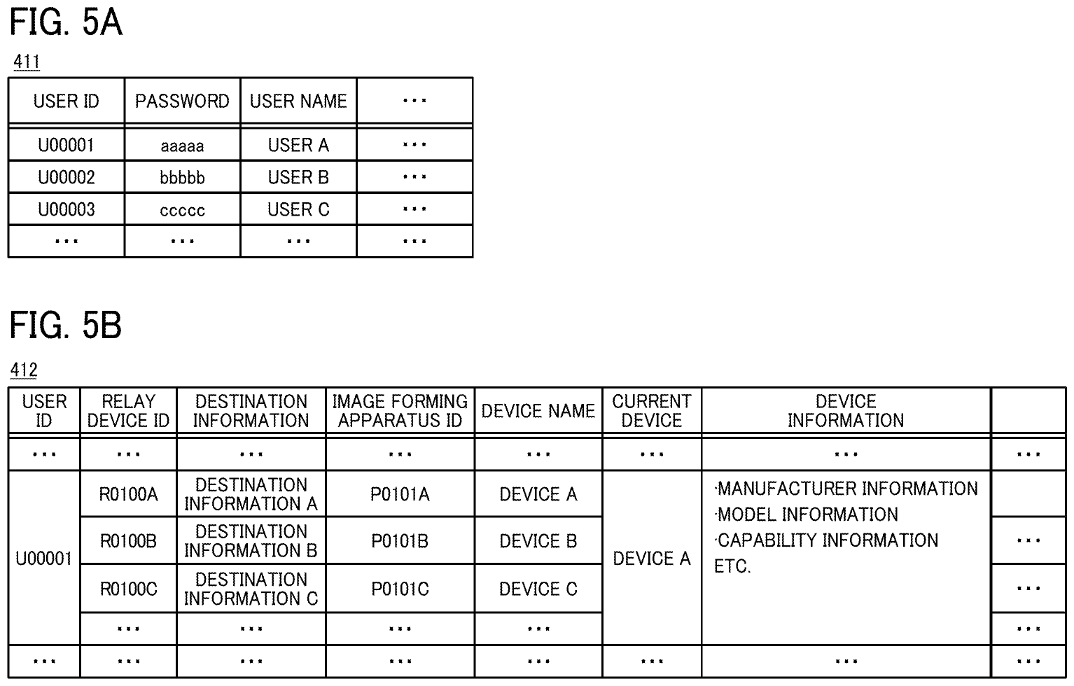

FIGS. 5A and 5B are diagrams illustrating examples of information managed by the print server 10 according to the one or more embodiments. FIG. 5A illustrates an example of the user information 411. In the example of FIG. 5A, the user information 411 includes information fields of a “user ID”, a “password”, and a “user name”.

The “user ID” is identification information for identifying a user. The “password” is an example of authentication information for used in authentication of a user. The authentication information for used in authentication of a user may be, for example, biometric information representing a feature quantity of a fingerprint or an iris of the user, or may be identification information given to an IC card or a terminal of the user. The “user name” is, for example, information such as the name of the user.

FIG. 5B illustrates an example of the contract information 412. In the example of FIG. 5B, the contract information 412 includes information fields of a “user ID”, a “relay device ID”, a “device name”, “destination information”, an “image forming apparatus ID”, a “current device”, and “device information”. The “user ID” is identification information for identifying a user. The “relay device ID” is identification information for identifying one or more relay devices 100 for which the user has a contract, that is, one or more relay devices 100 available to the user.

The “destination information” is, for example, destination information for use in communicating with the relay device 100, such as an Internet Protocol (IP) address or a Uniform Resource Locator (URL) of the relay device 100.

The “image forming apparatus ID” is identification information for identifying the image forming apparatus 101 connected to the relay device 100 corresponding to the “relay device ID”. The “device name” is information indicating a displayed name or the like of the relay device 100 or the image forming apparatus 101. The “current device” is information (for example, a device name, a relay device ID, or an image forming apparatus ID) indicating a default device selected by the user in a device setting process (described later) and to be used by the user. The “device information” is device information (for example, manufacturer information, model information, capability information, or option information) of the image forming apparatus 101 corresponding to the “current device”.

The authentication unit 408 in FIG. 4 uses, for example, the user information 411 to perform an authentication process of authenticating a user. For example, the authentication unit 408 uses authentication information of a user who attempts to log into the print server 10 from the information terminal 103, a user who attempts to log into the relay device 100, or the like to authenticate such a user. In one example, when a combination of a user ID and a password input to a login screen displayed by the relay device 100 is stored in the user information 411, the authentication unit 408 permits the user to log into the relay device 100.

The storage unit 410 is implemented by, for example, a program executed by the computer 200 and a storage device such as the HD204 included in the computer 200. The storage unit 410 stores, for example, the user information 411, the contract information 412, the document data 414, the print conditions 415, and the print data 416 that are described above.

The storage unit 410 may store printer drivers 413 for the plurality of image forming apparatuses 101a, 101b, 101c, . . . registered in the printing system 1. Alternatively, the print server 10 may acquire the printer drivers for the plurality of image forming apparatuses 101a, 101b, 101c, . . . from an external cloud service, a storage server, or the like. A printer driver is a program for controlling printing performed by the image forming apparatus 101. A printer driver has, for example, a function of displaying a print setting screen for setting the print conditions, a function of converting electronic data to be subjected to printing into print data in accordance with the set print conditions, and the like.

The functional configuration of the print server 10 illustrated in FIG. 4 is merely an example. For example, the functional configuration of the print server 10 illustrated in FIG. 4 may be distributed in a plurality of server devices. Alternatively, at least a part of the functional configuration of the print server 10 in FIG. 4 may be implemented by a program executed by a virtual computer or the like on a cloud.

### Functional Configuration of Printing System

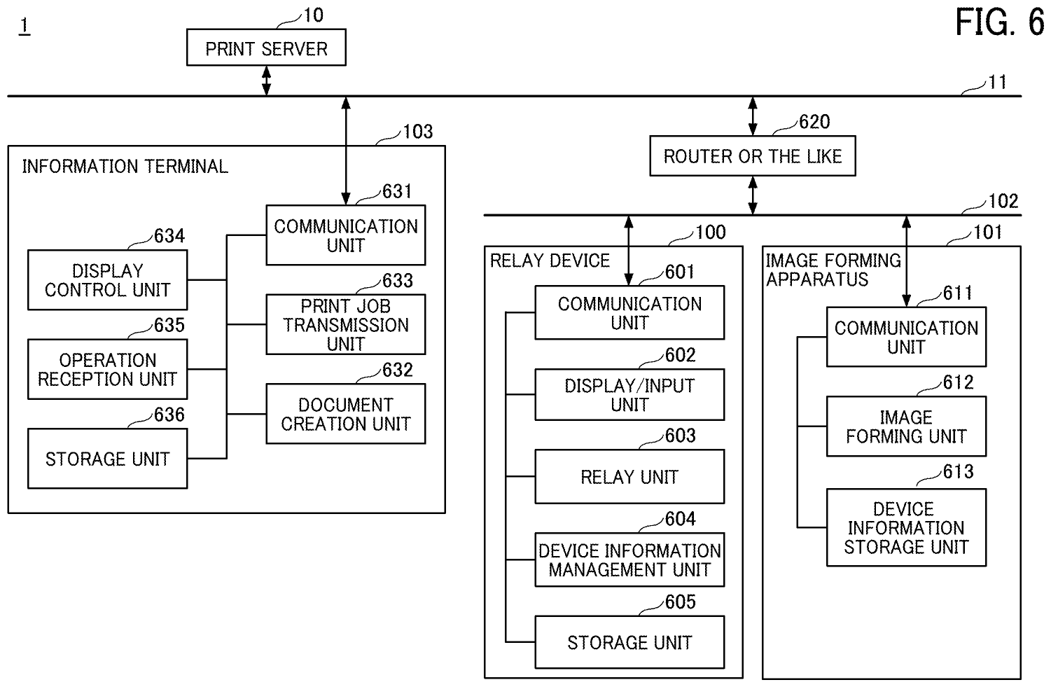

FIG. 6 is a block diagram illustrating an example of a functional configuration of the printing system 1 according to the one or more embodiments. In FIG. 6, the print server 10 has the functional configuration described with reference to FIG. 4.

The print server 10 and the information terminal 103 are connected to the communication network 11 such as the Internet. The relay device 100 and the image forming apparatus 101 are connected to a local network 120 that is connected to the communication network 11 via a router or the like 620. Thus, the relay device 100 is able to communicate with the print server 10 via the router or the like 620. The relay device 100 can also communicate with the image forming apparatus 101 via the local network 102. The router or the like 620 may include, for example, a firewall, a router, or the like.

### Functional Configuration of Relay Device

For example, the CPU 301 of the relay device 100 executes a predetermined program, so that the relay device 100 implements a communication unit 601, a display/input unit 602, a relay unit 603, a device information management unit 604, and a storage unit 605. At least a part of the above-described functional configuration may be implemented by hardware.

The communication unit 601 connects the relay device 100 to a network such as the local network 102 or the communication network 11 via, for example, the network I/F 304 and performs a communication process of communicating with the print server 10 and the image forming apparatus 101.

For example, the display/input unit 602 displays, on the display/input device 305, various display screens received from the display control unit 406 of the print server 10, and receives a user operation performed in such display screens. For example, the display/input unit 602 may have a function of a web browser and display a web page or the like provided by the display control unit 406 of the print server 10 on the display/input device 305.

The relay unit 603 performs a relay process of transferring print data received from the print server 10 to the image forming apparatus 101.

For example, the device information management unit 604 stores and manages, in the storage unit 605, information (for example, an image forming apparatus ID, an IP address, or the like) on the image forming apparatus 101 connected to or registered in the relay device 100. In response to a request from the print server 10, the device information management unit 604 acquires the device information of the image forming apparatus 101 from, for example, the image forming apparatus 101 and transmits the acquired device information to the print server 10. Alternatively, in response to a request from the print server 10, the device information management unit 604 may transmit the device information of the image forming apparatus 101 stored in advance in the storage unit 605 to the print server 10.

The storage unit 605 is implemented by, for example, a program executed by the CPU 301 and the storage device 303 or the like. The storage unit 605 stores the information of the image forming apparatus 101 and the device information managed by the device information management unit 604.

### Functional Configuration of Image Forming Apparatus

For example, a computer of the image forming apparatus 101 executes a predetermined program, so that the image forming apparatus 101 implements a communication unit 611, an image forming unit 612, a device information storage unit 613, for example.

The communication unit 611 connects the image forming apparatus 101 to, for example, a network such as the local network 102 and performs a communication process of communicating with the relay device 100. The image forming unit 612 performs an image formation process of printing print data received from the print server 10 via the relay device 100 using a printer engine or the like of the image forming apparatus 101. The device information storage unit 613 stores the device information of the image forming apparatus 101 in the storage device or the like of the image forming apparatus 101. As described above, the device information includes information on the PDL, sheet sizes, color or monochrome printing, single-sided or double-sided printing, stapling, scanning, and the like that can be handled by the image forming apparatus 101b.

In the present embodiments, the use of the above-described functions of the common image forming apparatus 101 is assumed.

### Information Terminal

For example, the CPU 201 of the information terminal 103 executes a predetermined program, so that the information terminal 103 implements a communication unit 631, a document creation unit 632, a print job transmission unit 633, a display control unit 634, an operation reception unit 635, and a storage unit 636. At least a part of the above-described functional configuration may be implemented by hardware.

The communication unit 631 connects the information terminal 103 to the communication network 11 using, for example, the network I/F 208, and performs a communication process of communicating with the print server 10.

The document creation unit 632 is implemented by, for example, a document creation application program executed by the CPU 201, and performs a document creation process of creating document data to be subjected to printing, which is an example of electronic data.

The print job transmission unit 633 is implemented by an application program (hereinafter, referred to as an app) corresponding to the printing system 1 and to be executed by the CPU 201 or by a printer driver or the like. The print job transmission unit 633 transmits a print job for printing the created document data to the print server 10.

The display control unit 634 is implemented by, for example, an app corresponding to the printing system 1 and to be executed by the CPU 201 or by a printer driver or the like. The display control unit 634 performs a display process of displaying various display screens related to the printing system 1 on the display 206.

The operation reception unit 635 receives an input operation performed by a user with an input device such as the keyboard 209 or the pointing device 210, for example. The storage unit 636 is implemented by, for example, a program executed by the CPU 201 and a storage device such as the HD 204 of the information terminals 103. The storage device 636 stores various kinds of information or data such as document data to be subjected to printing, which is electronic data.

The functional configuration of the printing system 1 illustrated in FIG. 6 is merely an example. For example, electronic data to be subjected to printing that is registered in the print server 10 by the information terminal 103 is not limited to document data created by the document creation unit 632, and may be image data read by a scanner, image data of an image captured by a digital camera, or the like.

### Processes

Processes of a printing control method according to the present embodiments will be described next.

### First Embodiment

### Device Setting Process

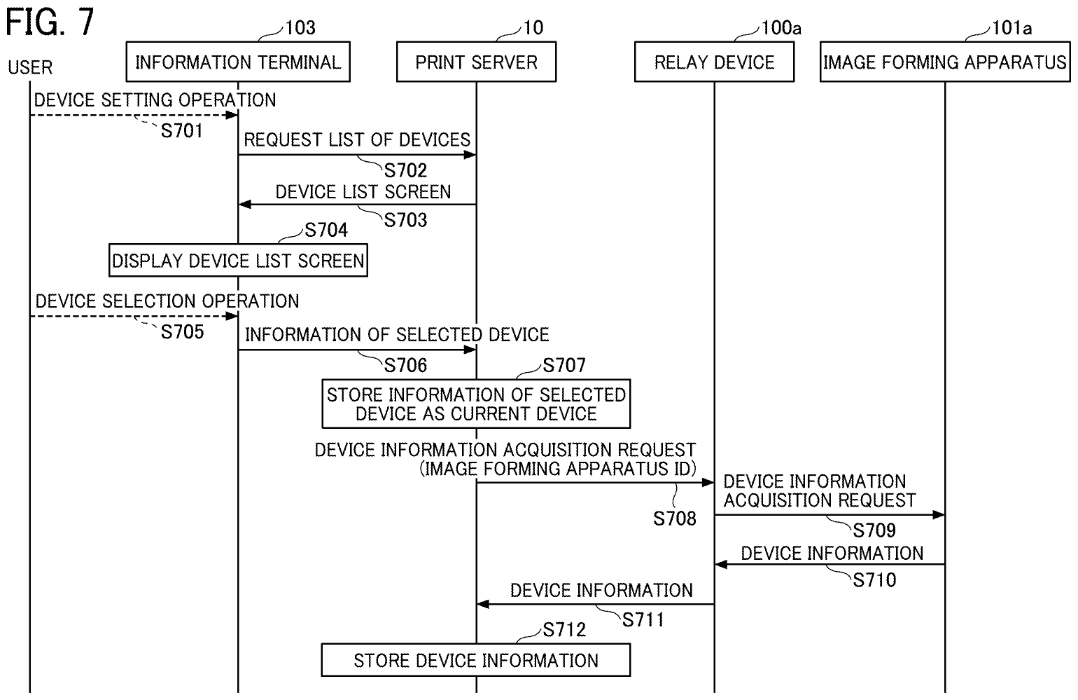

FIG. 7 is a sequence diagram illustrating an example of a device setting process according to a first embodiment. This process is an example of a device setting process in which a user registers, in the print server 10, a default device such as the relay device 100 or the image forming apparatus 101 that is usually used. At the start of the process illustrated in FIG. 7, the user has logged into the print server 10 using the information terminal 103.

In step S701, the user performs a device setting operation on the information terminal 103. Then, the printing system 1 performs processing of steps S702 to S704.

In step S702, in response to receipt of the device setting operation performed by the user, the operation reception unit 635 of the information terminal 103 requests the print server 10 to provide a list of devices available to the user.

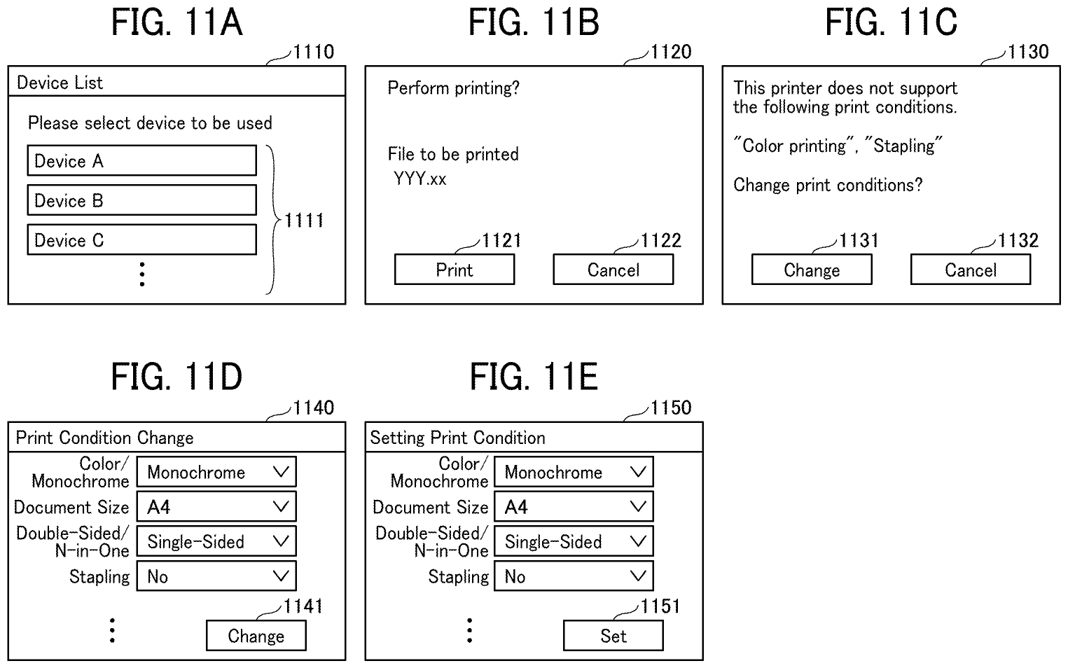

In step S703, in response to receipt of the request for the list of devices from the information terminal 103, the display control unit 406 of the print server 10 creates a list screen of the list of devices available to the user and transmits the list screen to the information terminal 103 that has transmitted the request. In one example, the display control unit 406 of the print server 10 acquires the device names of the devices such as the relay devices 100 or the image forming apparatuses 101 available to the logged-in user from the contract information 412 illustrated in FIG. 5B, and creates a device list screen 1110 illustrated in FIG. 11A. In the example illustrated in FIG. 11A, the device list screen 1110 displays a plurality of selection buttons 1111 that permit selection of the devices available to the user.

In step S704, the display control unit 634 of the information terminal 103 displays the device list screen 1110 received from the print server 10, on the display unit such as the display 206. The user can set a default device such as the relay device 100 or the image forming apparatus 101 usually used by the user in the displayed device list screen 1110.

In step S705, the user performs a selection operation of selecting the default device in the device list screen 1110. Then, the printing system 1 performs processing of step S706 and subsequent steps.

In step S706, in response to receipt of the selection operation performed by the user, the operation reception unit 635 of the information terminal 103 transmits information such as a device name of the selected device to the print server 10.

In step S707, the information management unit 407 of the print server 10 stores the information of the device received from the information terminal 103, as the “current device” in the contract information 412 illustrated in FIG. 5B, for example.

In step S708, the information management unit 407 of the print server 10 requests the relay device 100 corresponding to the “current device” to acquire the device information of the image forming apparatus 101. For example, in the contract information 412 illustrated in FIG. 5B, a relay device identifier (ID) “R0100A” corresponding to the device name “device A” is identification information of the relay device 100a, and the image forming apparatus ID “P0101A” is identification information of the image forming apparatus 101a. In this case, the information management unit 407 transmits a request to acquire the device information of the image forming apparatus 100a to the relay device 101a.

In steps S709 to S711, the device information management unit 604 of the relay device 100a acquires the device information from the image forming apparatus 101a and transmits the acquired device information to the print server 10.

In step S712, the information management unit 407 of the print server 10 stores the device information of the image forming apparatus 100a received from the relay device 101a as, for example, the “device information” of the contract information 412 illustrated in FIG. 5B.

Through the process illustrated in FIG. 7, the user can set (register), in the print server 10, the default device such as the relay device 100 or the image forming apparatus 101 that is usually used in the printing system 1.

### Print Job Registration Process

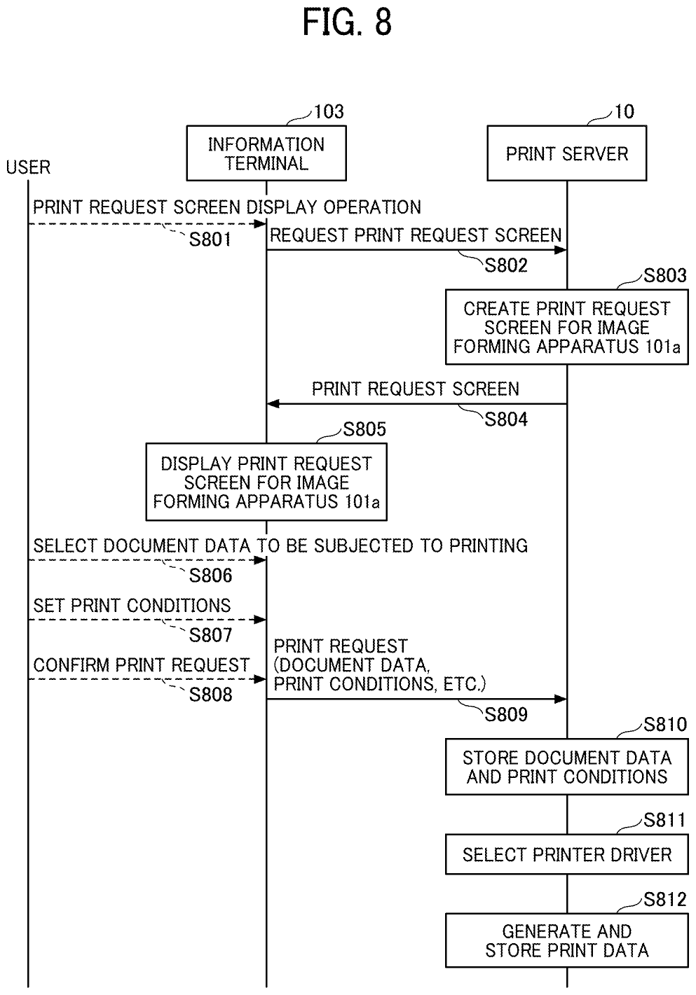

FIG. 8 is a sequence diagram illustrating an example of a print job registration process according to the first embodiment.

This process is an example of a print job registration process in which a user registers a print job in the print server 10. At the start of the process illustrated in FIG. 8, the user has logged into the print server 10 using the information terminal 103 and has performed the device setting process described with reference to FIG. 7 at least once.

In step S801, the user performs a print request screen display operation on the information terminal 103. Then, the printing system 1 performs processing of steps S802 to S805.

In step S802, in response to receipt of the print request screen display operation performed by the user, the operation reception unit 635 of the information terminal 103 requests the print server 10 to provide a print request screen.

In step S803, in response to receipt of the request for the print request screen from the information terminal 103, the display control unit 406 of the print server 10 identifies the image forming apparatus 101a corresponding to the current device “device A” with reference to the contract information 412 illustrated in FIG. 5B, for example. The display control unit 406 creates a print request screen for the image forming apparatus 101a, based on the device information of the image forming apparatus 101a stored in the contract information 412, for example. In one example, this print request screen may be a displayed screen similar to a print setting screen for the image forming apparatus 101a displayed in response to a print operation performed in a general application. At this time, the display control unit 406 may use, for example, the device information of the image forming apparatus 101a and the printer driver for the image forming apparatus 101a stored in the storage unit 410 to create the print setting screen.

In step S804, the display control unit 406 of the print server 10 transmits the created print request screen for the image forming apparatus 101a to the information terminal 103. Thus, in step S805, the display control unit 634 of the information terminal 103 displays, on the display unit such as the display 206, the print request screen for the image forming apparatus 101a received from the print server 10.

In steps S806 to S808, the user performs operations such as an operation of selecting document data to be subjected to printing, an operation of setting the print conditions, and an operation of confirming a print request in the print request screen displayed by the information terminal 103. If the user uses the printing function of the application to display the print request screen, the operation of selecting document data to be subjected to printing may be omitted.

In step S809, the operation reception unit 635 of the information terminal 103 transmits a print request including the document data to be subjected to printing (an example of electronic data) and the print conditions set by the user to the print server 10.

In step S810, the print job management unit 402 of the print server 10 stores the document data 414 and the print conditions 415 included in the print request received from the information terminal 103, in the storage unit 410 in association with the user ID of the user, for example.

In step S811, the print data generation unit 404 of the print server 10 selects a printer driver for the image forming apparatus 101a from among the printer drivers 413 stored in the storage unit 410.

In step S812, the print data generation unit 404 of the print server 10 uses the document data 414, the print conditions 415, and the printer driver for the image forming apparatus 101a that are stored in the storage unit 410 to generate print data that is printable by the image forming apparatus 101a. The print data generation unit 404 stores the generated print data 416 in the storage unit 410 in association with the document data 414 and the print conditions 415.

Through the process illustrated in FIG. 8, the user uses the relay device 100a illustrated in FIG. 1 to be able to register, in the print server 10, a print job for printing the document data with the image forming apparatus 101a.

### Printing Process

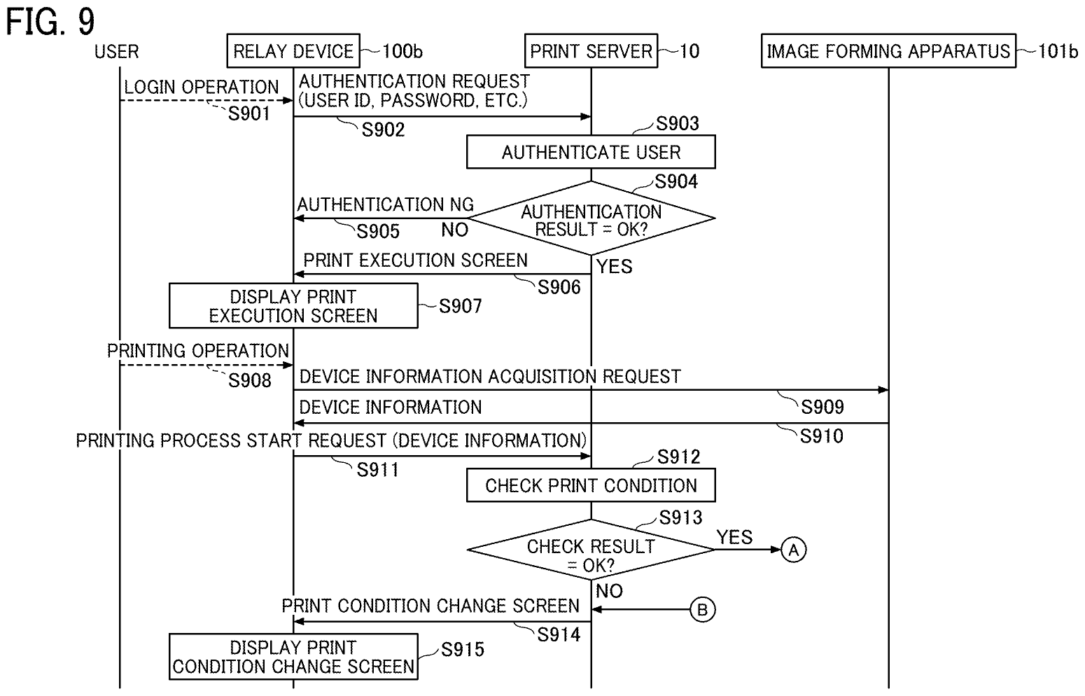

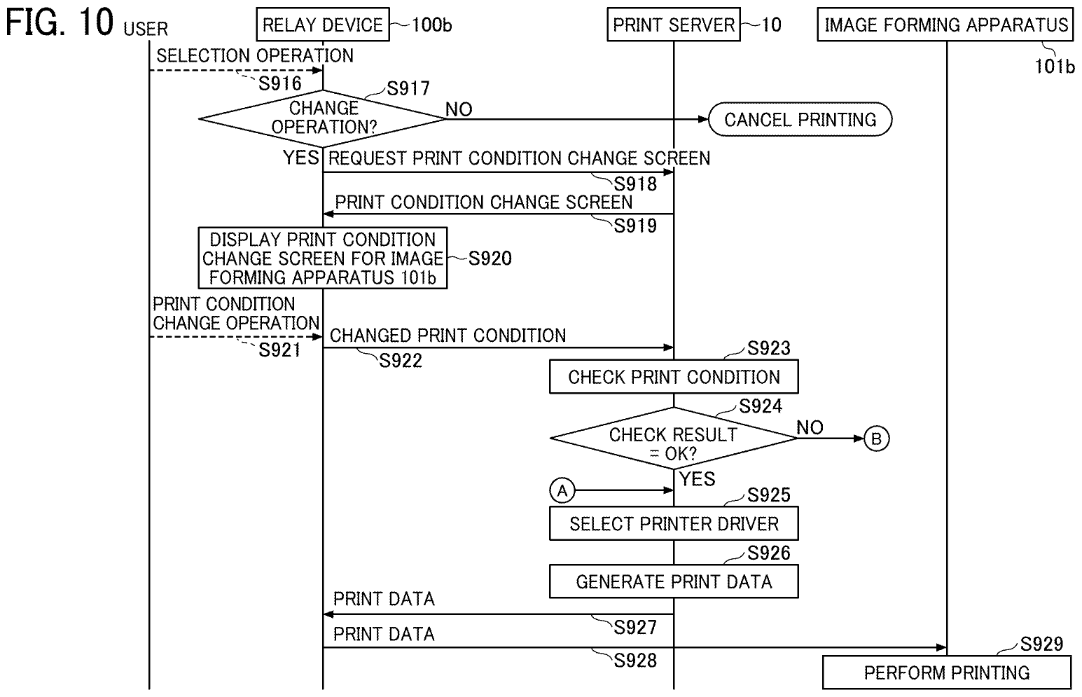

FIGS. 9 and 10 are sequence diagrams illustrating an example of a printing process according to the first embodiment. This process is an example of a printing process performed in the case where a print job registered in the print server 10 by a user so that printing is performed by the image forming apparatus 101a is printed by another image forming apparatus 101b. At the start of the process illustrated in FIG. 9, the print job registration process described with reference to FIG. 8 has been performed.

In step S901, the user preforms a login operation on the relay device 100b. In one example, the user inputs a user ID and a password in a login screen of the relay device 100b. However, the login operation is not limited this, and the login operation may be performed using, for example, an IC card, a smartphone, or a fingerprint.

In step S902, in response to receipt of the login operation performed by the user, the operation reception unit 635 of the information terminal 103 transmits an authentication request including authentication information (for example, the user ID and the password) of the user to the print server 10.

In step S903, in response to the authentication request received from the information terminal 103, the authentication unit 408 of the print server 10 performs authentication of the user. For example, if a combination of the user ID and the password included in the authentication request is stored in the user information 411 illustrated in FIG. 5A, the authentication unit 408 determines that an authentication result is OK (successful). However, the manner of authentication is not limited this. The authentication unit 408 may request an external authentication server or the like to authenticate the user.

If the authentication result of the user is OK in step S904, the authentication unit 408 causes the process to proceed to step S906. On the other hand, if the authentication result of the user is not OK, the authentication unit 408 notifies the relay device 100b of the authentication result indicating that the authentication is unsuccessful in step S905. The process then ends.

In step S906, the display control unit 406 of the print server 10 transmits a print execution screen 1120 (see FIG. 11B) to the information terminal 103. In response to this, in step S907, the display/input unit 602 of the relay device 100 displays, for example, the print execution screen 1120 illustrated in FIG. 11B on the display/input device 305 or the like. In the example of FIG. 11B, for example, a “print” button 1121, a “cancel” button 1122, and the like are displayed in the print execution screen 1120 together with information of a file to be subjected to printing (electronic data).

The user selects the “print” button 1121 in the print execution screen 1120 to be able to perform a print operation for requesting the start of a printing process. In this way, the printing system 1 performs control such that the printing process does not start until the user selects the “print” button 1121 in the print execution screen 1120. Thus, for example, the user can print the print job registered in the print server 10 so as to be printed by the image forming apparatus 101a, with another one of the image forming apparatuses 101b, 101c, . . . .

In step S908, the user performs a printing operation in the print execution screen 1120. Then, the printing system 1 performs the processing of step S909 and subsequent steps.

In steps S909 to S911, the device information management unit 604 of the relay device 100b acquires the device information from the image forming apparatus 101b, and transmits a printing process start request including the acquired device information of the image forming apparatus 101b to the print server 10. As described above, the device information of the image forming apparatus 101b includes information on the PDL, sheet sizes, color or monochrome printing, single-sided or double-sided printing, stapling, and scanning that can be handled by the image forming apparatus 101b. The device information management unit 604 may transmit, to the print server 10, a printing process start request including the device information of the image forming apparatus 101b stored in advance in the storage unit 605.

In step S912, the check unit 403 of the print server 10 checks whether the image forming apparatus 101b is capable of printing the document data 414 registered in the print server 10 by the user in accordance with the print conditions 415 of the document data 414. For example, when “color printing” and “stapling” are set by the user as the print conditions 415 of the document data 414 registered in the print server 10, the check unit 403 checks whether the image forming apparatus 101b has the functions of “color printing” and “stapling”.

If the check result obtained by the check unit 403 is OK in step S913, the print server 10 causes the process to proceed to step S925 of FIG. 10. On the other hand, if the check result obtained by the check unit 403 is not OK, the print server 10 causes the process to proceed to S914.

In step S914, the display control unit 406 of the print server 10 transmits a print condition change screen 1130 (see FIG. 11C) to the relay device 100b. Thus, in step S915, the display/input unit 602 of the relay device 100 displays, for example, the print condition change screen 1130 illustrated in FIG. 11C on the display/input devices 305 or the like.

In the example of FIG. 11C, a message indicating that the image forming apparatus 101b that is the destination of printing does not support “color printing” and “stapling” among the print conditions 415 set by the user is displayed in the print condition change screen 1130. The print condition change screen 1130 also displays a “change” button 1131 for receiving a print condition change operation and a “cancel” button 1132 for receiving a printing canceling operation.

In step S916 of FIG. 10, the user performs a selection operation in the print condition change screen 1130. Then, the printing system 1 performs processing of steps S917 to S920.

In step S917, the display/input unit 602 of the relay device 100b determines whether the selection operation performed by the user is a change operation. If the selection operation performed by the user is a change operation, the display/input unit 602 causes the process to proceed to step S918. On the other hand, if the selection operation performed by the user is not the change operation, the display/input unit 602 cancels the printing process.

In step S918, the display/input unit 602 of the relay device 100b requests the print server 10 to provide a print condition change screen.

In step S919, the display control unit 406 of the print server 10 transmits a print condition change screen 1140 (see FIG. 11D) to the relay device 100b. Thus, in step S920, the display/input unit 602 of the relay device 100b displays, for example, the print condition change screen 1140 illustrated in FIG. 11D on the display/input devices 305 or the like.

In the example of FIG. 10D, a plurality of print conditions such as “color/monochrome”, “document size”, “double-sided/n-in-one”, and “stapling” are displayed in the print condition change screen 1140 in a changeable manner, for example. The user changes any of the above print conditions and selects a “change” button 1141 to be able to perform the printing condition change operation.

For example, since the print condition change screen 1130 in FIG. 10C indicates that the image forming apparatus 101b does not support “color printing” and “stapling”, the user may set “color/monochrome” to monochrome and set “stapling” to no. Thus, the user can print, with the image forming apparatus 101b, the document data 414 registered in the print server 10.

The print condition change screen 1140 illustrated in FIG. 11D is an example. For example, the display control unit 406 of the print server 10 may cause the relay device 101b to display the print condition change screen 1140 that displays merely a print condition not supported by the image forming apparatus 100b in a changeable manner. Alternatively, the display control unit 406 of the print server 10 may automatically change a print condition not supported by the image forming apparatus 101b to a supported print condition, and may just receive a change operation (or a confirmation operation) from the user.

In step S921, the user performs a print condition change operation in the print condition change screen 1140. Then, the printing system 1 performs the processing of step S922 and subsequent steps.

In step S922, the display/input unit 602 of the relay device 100b transmits the print condition changed by the user to the print server 10.

In step S923, the check unit 403 of the print server 10 checks whether the document data 414 registered in the print server 10 by the user is printable by the image forming apparatus 101b in accordance with the print conditions changed by the user.

If the check result obtained by the check unit 403 is OK in step S924, the print server 10 causes the process to proceed to step S925. On the other hand, if the check result obtained by the check unit 403 is not OK, the print server 10 returns the process to step S914 in FIG. 9.

In step S925, the print data generation unit 404 of the print server 10 selects a printer driver corresponding to the image forming apparatus 101b from the printer drivers 413 stored in the storage unit 410.

In step S926, the print data generation unit 404 of the print server 10 uses the selected printer driver to convert the document data 414 registered by the user in accordance with the print conditions. In this manner, the print data generation unit 404 generates print data printable by the image forming apparatus 101b.

In step S927, the transmission unit 405 of the print server 10 transmits the generated print data to the relay device 100b. In step S928, the relay unit 603 of the relay device 100b transfers the print data received from the print server 10 to the image forming apparatus 101b.

In step S929, the image forming unit 612 of the image forming apparatus 101b prints the print data received from the relay device 100b.

As described above, according to the first embodiment, the printing system 1 that performs printing using the print server 10 makes it easier to perform printing based on a print job registered in the print server 10, with various image forming apparatuses of different manufacturers, models, options, or the like.

### Second Embodiment

In the first embodiment, in response to receipt of a print request including the document data 414 and the print conditions 415 from the information terminal 103, the print server 10 converts the document data 414 into the print data 416.

In a second embodiment, description will be given of an example of a process performed in the case where the print conditions 415 are not designated when the print server 10 receives the document data 414 from the information terminal 103. The functional configuration of the printing system 1 according to the second embodiment may be the same or substantially the same as the functional configuration of the printing system 1 according to the first embodiment.

### Processes

### Print Job Registration Process

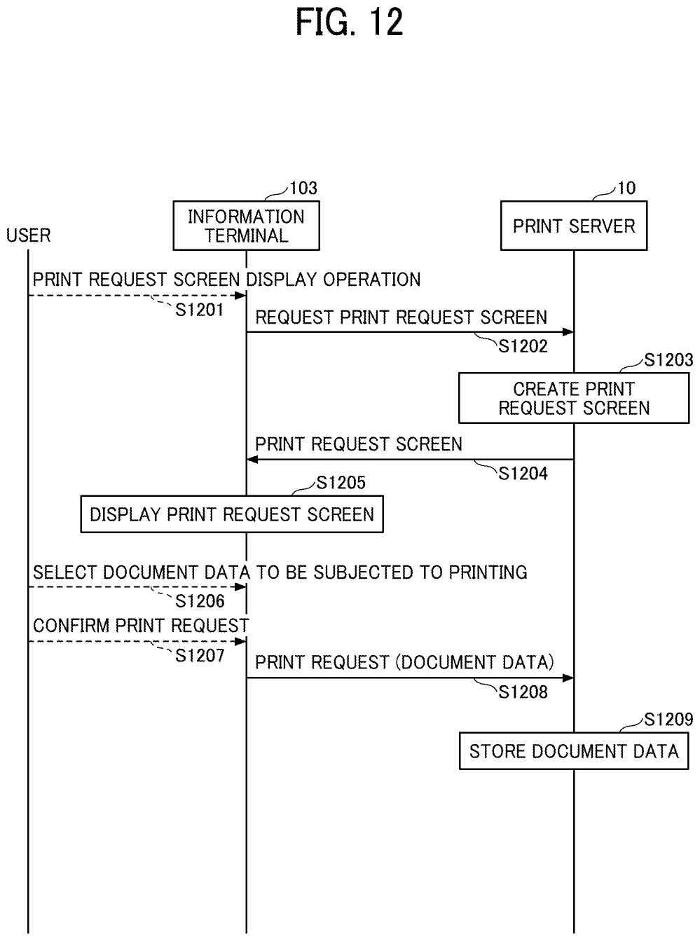

FIG. 12 is a sequence diagram illustrating an example of a print job registration process according to the second embodiment. This process is another example of a print job registration process in which a user registers a print job in the print server 10. At the start of the process illustrated in FIG. 12, the user has logged into the print server 10 using the information terminal 103 and has performed the device setting process described with reference to FIG. 7 at least once. Detailed description of the same or similar processing content as that of the first embodiment is omitted.

In step S1201, the user performs a print request screen display operation on the information terminal 103. Then, the printing system 1 performs processing of steps S1202 to S1205.

In step S1202, in response to receipt of the print request screen display operation performed by the user, the operation reception unit 635 of the information terminal 103 requests the print server 10 to provide a print request screen.

In step S1203, in response to receipt of the request for the print request screen from the information terminal 103, the display control unit 406 of the print server 10 creates the print request screen. In the second embodiment, the display control unit 406 creates the print request screen that is independent of the model of the image forming apparatus 101 and that receives selection of document data to be subjected to printing, for example.

In step S1204, the display control unit 406 of the print server 10 transmits the created print request screen to the information terminal 103. Thus, in step S1205, the display control unit 634 of the information terminal 103 displays the print request screen received from the print server 10 on the display unit such as the display 206.

In steps S1206 and S1207, the user performs, for example, an operation of selecting document data to be subjected to printing and an operation of confirming a print request in the print request screen displayed by the information terminal 103.

In step S1208, the operation reception unit 635 of the information terminal 103 transmits a print request including the document data to be subjected to printing, which is an example of electronic data, to the print server 10.

In step S1209, the print job management unit 402 of the print server 10 stores the document data 414 included in the print request received from the information terminal 103 in the storage unit 410 in association with the user ID of the user, for example.

Through the process illustrated in FIG. 12, the user can register a print job that is independent of the model of the image forming apparatus 101 in the print server 10.

### Printing Process

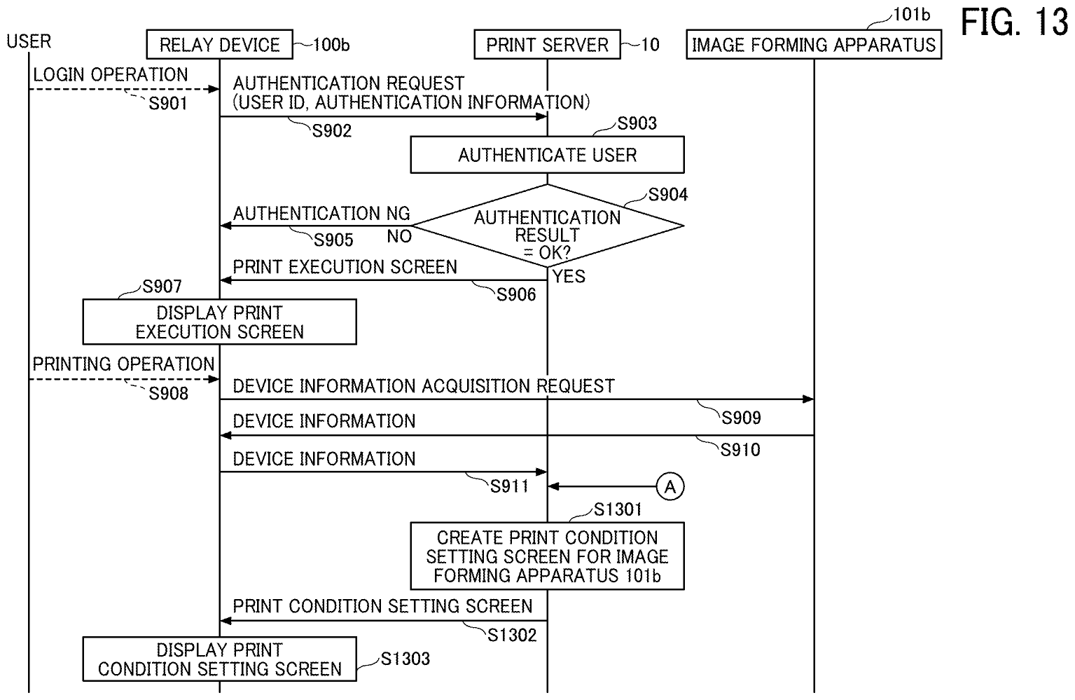

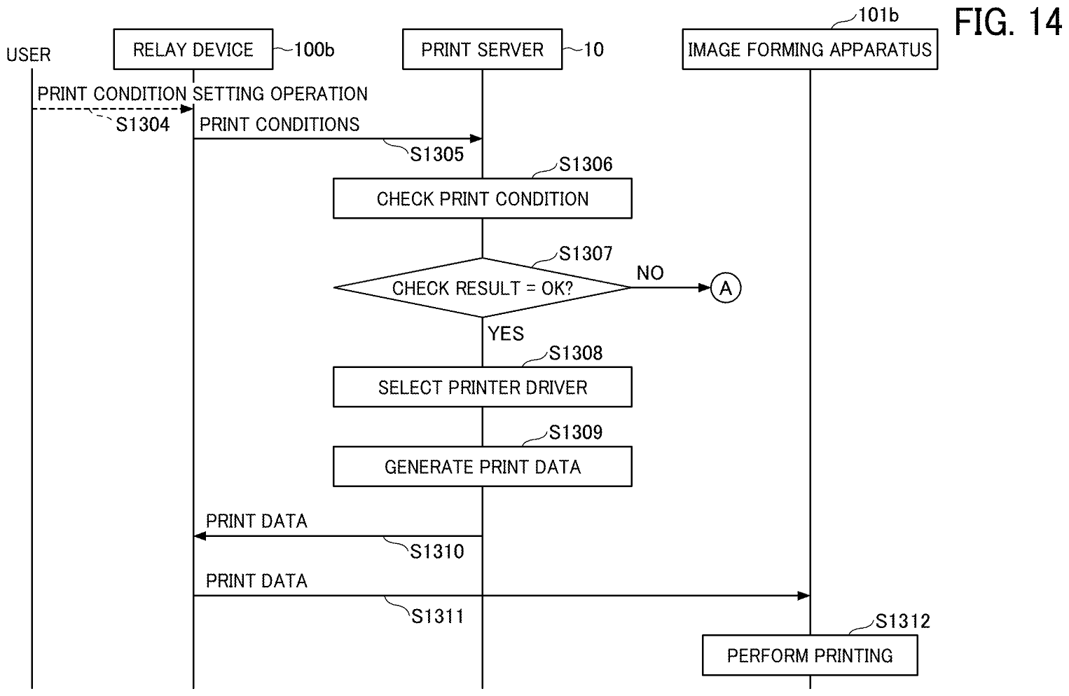

FIGS. 13 and 14 are sequence diagrams illustrating an example of a printing process according to the second embodiment. This process is an example of a printing process performed in the case where a print job that is registered in the print server 10 by the user and is independent of the model of the image forming apparatus 101 is printed by the image forming apparatus 101b. Since processing of steps S901 to S911 of the process illustrated in FIG. 13 is substantially the same as that of the printing process according to the first embodiment described with reference to FIG. 9, description thereof is omitted.

In step S1301, the display control unit 406 of the print server 10 creates a print condition setting screen for the image forming apparatus 101b. This print condition setting screen may be substantially the same as, for example, a print setting screen displayed by a printer driver for the image forming apparatus 101a. In this case, the display control unit 406 uses the device information of the image forming apparatus 101b and a printer driver for the image forming apparatus 101b stored in the storage unit 410 to be able to create the print setting screen. Alternatively, the display control unit 406 may create a print condition setting screen 1150 illustrated in FIG. 11E, for example.

In step S1302, the display control unit 406 of the print server 10 transmits the created print condition setting screen for the image forming apparatus 101b to the relay deice 100b. Thus, in step S1303, the display/input unit 602 of the relay device 100b displays the print condition setting screen for the image forming apparatus 101b received from the print server 10 on the display unit such as the display/input device 305.

Subsequently, in step S1304 of FIG. 14, the user performs a print condition change operation in the print condition setting screen. Then, the printing system 1 performs the processing of step S1305 and subsequent steps.

In step S1305, the display/input unit 602 of the relay device 100b transmits the print conditions changed by the user to the print server 10.

In step S1306, the check unit 403 of the print server 10 checks whether the document data 414 registered in the print server 10 by the user is printable by the image forming apparatus 101b in accordance with the print conditions changed by the user.

If the check result obtained by the check unit 403 is OK in step S1307, the print server 10 causes the process to proceed to step S1308. On the other hand, if the check result obtained by the check unit 403 is not OK, the print server 10 returns the process to step S1301 in FIG. 13.

In step S1308, the print data generation unit 404 of the print server 10 selects a printer driver corresponding to the image forming apparatus 101b from the printer drivers 413 stored in the storage unit 410.

In step S1309, the print data generation unit 404 of the print server 10 uses the selected printer driver to convert the document data 414 registered by the user in accordance with the print conditions. In this manner, the print data generation unit 404 generates print data printable by the image forming apparatus 101b.

In step S1310, the transmission unit 405 of the print server 10 transmits the generated print data to the relay device 100b. In step S1311, the relay unit 603 of the relay device 100b transfers, to the image forming apparatus 101b, the print data received from the print server 10.

In step S1312, the image forming unit 612 of the image forming apparatus 101b prints the print data received from the relay device 100b.

As described above, in the case where the print conditions 415 are not designated when the document data 414 is received from the information terminal 103, the print server 10 may store the document data 414 as a print job in the storage unit 410 without converting the document data 414 into print data.

As described above, according to each of the embodiments of the present disclosure, the printing system 1 that performs printing using the print server 10 makes it easier to perform printing based on a print job registered in the print server 10, with various image forming apparatuses of different manufacturers, models, options, or the like.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The group of apparatuses and devices described in the embodiments merely presents one of a plurality of computing environments for implementing the embodiments disclosed herein. In one embodiment, the print server 10 includes a plurality of computing devices such as a server cluster.

The plurality of computing devices communicate with each other via a communication link of any type including a network, shared memory, or the like and perform the processes disclosed herein.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

In one embodiment, the present invention resides in a non-transitory recording medium storing a plurality of instructions which, when executed by one or more processors, cause the processors to perform a printing control method including: checking whether electronic data to be printed is printable by an image forming apparatus in accordance with a print condition of the electronic data; causing a relay device capable of communicating with the image forming apparatus to display a change screen for receiving a change of the print condition in a case where the electronic data is not printable by the image forming apparatus in accordance with the print condition; converting, in a case where the print condition is changed, the electronic data into print data printable by the image forming apparatus in accordance with the changed print condition; and transmitting the print data to the relay device.

1. A printing system comprising:
a print server; and
a relay device communicably connected with the print server and an image forming apparatus,
the print server including circuitry configured to
check whether electronic data to be printed is printable by the image forming apparatus in accordance with a print condition of the electronic data,
cause the relay device to display a change screen for receiving a change of the print condition in a case where the electronic data is not printable by the image forming apparatus in accordance with the print condition,
convert, in a case where the print condition is changed, the electronic data into print data printable by the image forming apparatus in accordance with the changed print condition, and
transmit the print data to the relay device.

2. The printing system according to claim 1, wherein the relay device including circuitry configured to
display the change screen on a display, and
transfer, to the image forming apparatus, the print data received from the print server.

3. The printing system according to claim 1, wherein the circuitry of the print server is configured to check whether the electronic data is printable by the image forming apparatus in accordance with the print condition, based on the print condition and device information of the image forming apparatus.

4. The printing system according to claim 3, wherein
the circuitry of the print server is configured to execute a printer driver corresponding to the image forming apparatus, and
the printer driver is configured to perform the check, based on whether PDL conversion is successfully performed on the electronic data in accordance with the print condition.

5. The printing system according to claim 1, wherein the circuitry of the print server is configured to
cause the relay device to display a print execution screen for receiving an operation of performing printing of the electronic data, and
start the check in response to receipt of the operation of performing the printing.

6. The printing system according to claim 1, further comprising:
an information terminal communicably connected to the print server, wherein
the circuitry of the print server is configured to convert the electronic data into print data in response to receipt of the electronic data and the print condition from the information terminal.

7. The printing system according to claim 6, wherein the circuitry of the print server is configured to store the electronic data in a memory without converting the electronic data into print data in a case where the print condition is not designated at receipt of the electronic data from the information terminal.

8. A print server communicably connected, via a communication network, to a relay device capable of communicating with an image forming apparatus, the print server comprising circuitry configured to
check whether electronic data to be printed is printable by the image forming apparatus in accordance with a print condition of the electronic data,
cause the relay device to display a change screen for receiving a change of the print condition in a case where the electronic data is not printable by the image forming apparatus in accordance with the print condition,
convert, in a case where the print condition is changed, the electronic data into print data printable by the image forming apparatus in accordance with the changed print condition, and
transmit the print data to the relay device.

9. A printing control method comprising:
checking whether electronic data to be printed is printable by an image forming apparatus in accordance with a print condition of the electronic data;
causing a relay device capable of communicating with the image forming apparatus to display a change screen for receiving a change of the print condition in a case where the electronic data is not printable by the image forming apparatus in accordance with the print condition;
converting, in a case where the print condition is changed, the electronic data into print data printable by the image forming apparatus in accordance with the changed print condition; and
transmitting the print data to the relay device.
